(19) United States
(12) Patent Application Publication
(10) Pub. No.: US 2014/0143355 A1
(43) Pub. Date: May 22, 2014

(54) Method and System for Video Texting

(71) Applicants: Bert Berdis, Los Angeles, CA (US); Daniel Collins, West Hollywood, CA (US); Evan Frankfort, West Toluca Lake, CA (US); Daniel Leeb, Los Angeles, CA (US); Richard Beanland, Dallas, TX (US)

(72) Inventors: Bert Berdis, Los Angeles, CA (US); Daniel Collins, West Hollywood, CA (US); Evan Frankfort, West Toluca Lake, CA (US); Daniel Leeb, Los Angeles, CA (US); Richard Beanland, Dallas, TX (US)

(21) Appl. No.: 13/918,775

(22) Filed: Jun. 14, 2013

Related U.S. Application Data
(60) Provisional application No. 61/659,941, filed on Jun. 14, 2012.

(51) Int. Cl. H04L 12/58

(52) U.S. Cl. CPC H04L 51/04
USPC 709/206

(57) ABSTRACT

The present invention provides a method, apparatus and computer readable medium for transmitting a video text message including receiving a text message via a text messaging application on a first mobile device. Based on the input, the next steps are determining a search query term for searching one or more libraries of video clips and accessing the one or more libraries of video clips using the search query term to retrieve a plurality of video clips. Thereupon, further steps are presenting the plurality of video clips to the user in the text message application and receiving a user selection of one of the plurality of video clips. As such, the method, apparatus and computer readable medium combines the selected video clip with the text message to generate the video message and provides for transmission to the second mobile device for viewing thereon.

### RELATED APPLICATIONS

The present invention relates to and claims priority to U.S. Provisional Patent Application Ser. No. 61/659,941 filed Jun. 14, 2012.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The present invention relates generally to electronic messaging technology and more importantly to electronic messaging technology that includes video.

### BACKGROUND OF THE INVENTION

The rapid growth of mobile communications has spawned many developments. Original growth spawned from electronic mail messaging and quickly expanded with mobile communication. Early communication techniques included short messaging systems (SMS), which restricted the communication to a short text message. These limitations were often based on available bandwidth and network restrictions, thus allowing for a person to send a short SMS message.

As mobile technology improved and bandwidth speed increased, a next iteration for message was multimedia-messaging systems (MMS). These allowed for the transmission of large content items. For example, a user could send an image and a text message. MMS also allowed for the transmission of longer text messages. And the MMS platform has since evolved to allow for the transmission of video content, enabled by network bandwidth, improved compression technology and improved mobile device technology.

Regardless of technological growth, basic problems still exist to the human element in usage of these systems. These messages collectively referred to hereafter as text messages, suffer from a lack of human context. For example, in a typical exchange, a person's text message includes a short message without the recipient being able to fully appreciate the context of the message. Emoticons can be used to try to convey emotion, but these are still subject to misinterpretation. By way of example, supposed a sender wishes to convey sincerity in a message, this can be interpreted as being sarcastic.

The short and static nature of text messages makes them vulnerable to being misinterpreted by the recipient. This is unfortunate, as the existing mobile technology has removed the restrictions of the amount of content available in text messages. Personal communications have rapidly evolved through voice calls, emails, and, for now, have settled on text messaging in numbers no one could have predicted five years ago. In 2010 over 90 Billion text messages are sent every month. The average text messages sent per month are 357. Teens average 3,300/months. 138 million Americans have sent a text message in the past three months.

Currently, an existing technique for sending video text messages is described in U.S. Patent Application Publication 2009/0156170 (“Rossano”). The Rossano system encompasses and embodies the problems with existing video text messaging systems, including the problems with disparate systems and requiring multiple user interfaces. By way of example, Rossano requires a first interface for searching operations, the user entering specific search terms for video clip search results. Then, under the Rossano system, the user must select and purchase a video clip from the first interface before the video clip is made available for a second interface to include the text message. Rossano's payment-based system provides for the disparate interfaces between searching, paying and subsequent text messaging, the user and/or user's computer is required to engage in multiple different applications and platforms to engage the system in a manner that allows for the entrance of a text message and its subsequent transmission.

As such, there exists a need for a user-friendly technique to allow for the sending of text messages that allow the user to better convey a context in a seamless, more efficient manner.

### SUMMARY OF THE INVENTION

The present invention provides a method and system for sending video text messaging that allow contextual association for text message content. The method and system is referred to herein as video texting, a combination of video and text messaging. The method and system can operate from multiple platforms and various embodiments are within the scope of the invention.

For example, one embodiment includes video texting from the user mobile device, wherein functionality and content is contained therein. In another example, video texting may be performed via one or more central platforms, offloading processing and content for the mobile device. In another example, the processing and functionality may be distributed between the mobile and one or more central platforms. The corresponding embodiments can accompany not only the message transmission, but also the functionality at the corresponding recipient device.

In a general embodiment, the method and system for video texting includes a user performing a video content search. This content search may be a directed search integrated with the content of a text message, e.g. as the user enters the text message, the words of the text message become the search query terms. Therefore, in this single system, the user enters the text message as the search query terms. This system therein uses the text message for performing searching operations for finding a plurality of video clips. In response to video content searching, the user is presented with the plurality of video clips. The user can preview various clips using a clip-viewing interface and then select a particular video clip.

The video clip is then associated with the text message in any number of possible ways, including but not limited to being embedded in the text message or having a link or pointer to a content database. Once the video text message is completed, the message can then be transmitted using standard transmission techniques to the intended recipient.

As described in further detail below, the video clip and associated data may be centrally hosted on one or more platforms. For instance, one embodiment integrates the video content with a search engine database. In another instance, the system uses one or more separate video content databases to host various video content and the search engine and/or system accesses these databases to retrieve corresponding content.

The recipient, upon receipt, is operative to receive the text message and the corresponding video clip. The execution of the video clip therein provides a visual context to the sender's text message. The recipient can correspondingly respond to the video text using similar techniques, including sending a text message that can include a video, if the recipient desires.

In additional embodiments, users have the ability to select different levels of video content based on costs and/or subscriptions. The levels of video content can range from a free content version available to all users to a subscription service providing privileged access to proprietary content. Other embodiments allow for the insertion of advertising or product placements in the video text message, which may be associated with the subscription or pricing model, for example a subscribed user may exclude advertising, whereas free users may be subject to advertising.

Generally speaking, video texting is a godsend for every shy guy and bashful girl. Guys are terrified of trying to be funny. Girls are equally frightened of showing their emotions. Consequently, using existing prior system, text messages end up simply being, “what's up?” In other words, everyone is afraid of trying to be creative. However, using the tools provided by the present invention, a sender can suddenly be as witty as Woody Allen or as charming as Cary Grant. With one keystroke, a new world of personal expression opens up. It expands the horizons of text by using video to interpret any message with—emotion—comedy or drama—and enables the sender to break through the clutter of sameness.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a block diagram of one embodiment of a processing system for video texting;

FIG. 2 illustrates a block diagram of another embodiment of a processing system for video texting;

FIG. 3 illustrates a flowchart of the steps of one embodiment of a video texting method;

FIG. 4 illustrates a flowchart of the steps of another embodiment of a video texting method; and

FIGS. 5-12 illustrate sample screen shots of one or more embodiments of a video texting system and method.

### DETAILED DESCRIPTION

In the following description, reference is made to the accompanying drawings that form a part hereof, and in which is shown by way of illustration specific embodiments in which the invention may be practiced. It is to be understood that other embodiments may be utilized and design changes may be made without departing from the scope of the present invention.

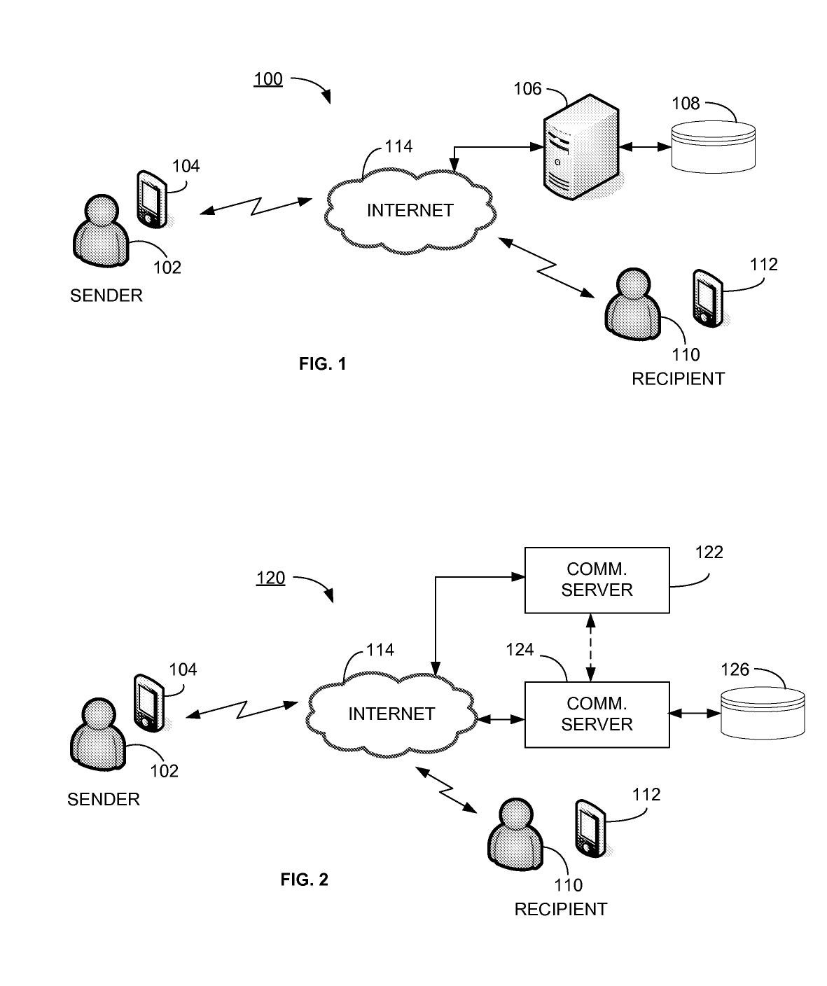

FIG. 1 illustrates one embodiment of a system 100 that includes a sender 102 with a mobile computing device 104, a video text server 106 with a database 108, a recipient 110 with a recipient mobile device 112 and a network 114.

The user 102 may be any suitable user having a communication device 104, such as the mobile device illustrated herein. The mobile device 104 is not expressly limited to a mobile device such as a smart phone, tablet computer, laptop computer, etc., but may also incorporate a home or desktop computer having the corresponding functionality described herein. The same description equally applies to the recipient 110 and recipient device 112, such as for example while one embodiment includes mobile to mobile texting operations, it is recognized that users may be communicating across desktop computers or other interfaces, including by way of example, but not expressly limiting, an Internet-enabled video television interface.

The video texting server 106 may be one or more remotely accessible processing devices having processing operations accessible via the network 114, for performing the operations described herein. The network 114 may be the Internet, but it is recognized that this may include, but not restricted to, wired or wireless communication access points and may include intermediate access via mobile access providers or wireless access providers. By way of example, a computing device may use a cellular network to access the network or a wireless interface to access the network. For the sake of brevity, intermediate communication access descriptions, well known in the art, have been omitted herewith.

The database 108 may be any number of data storage devices. For example, one device may include computer readable media capable of storing executable instructions for the video texting server 106 to perform the corresponding operations. The database 108 may include a library of video clips, as described in further detail below. Additionally, the database 108 may be a collection of databases from one or more sources providing video clips for these different sources. For example, various content providers might provide their corresponding content, thus content can be disposed in a distributed environment and is not necessarily centrally disposed.

Moreover, another embodiment provides for the video texting server 106 to be any number of various servers with access to different databases 108, such as for example providing front-end search or interface access to the various databases 108. In this embodiment, a first server of the video text server 106 might provide search interface operations and secondary servers provide and compliment the search interface for providing corresponding located.

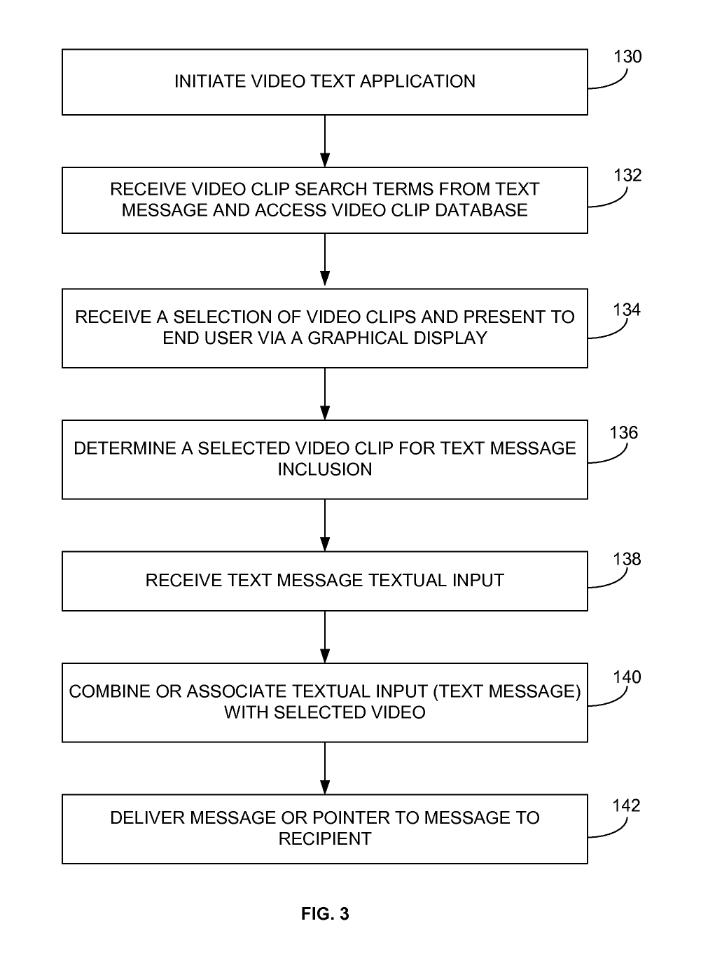

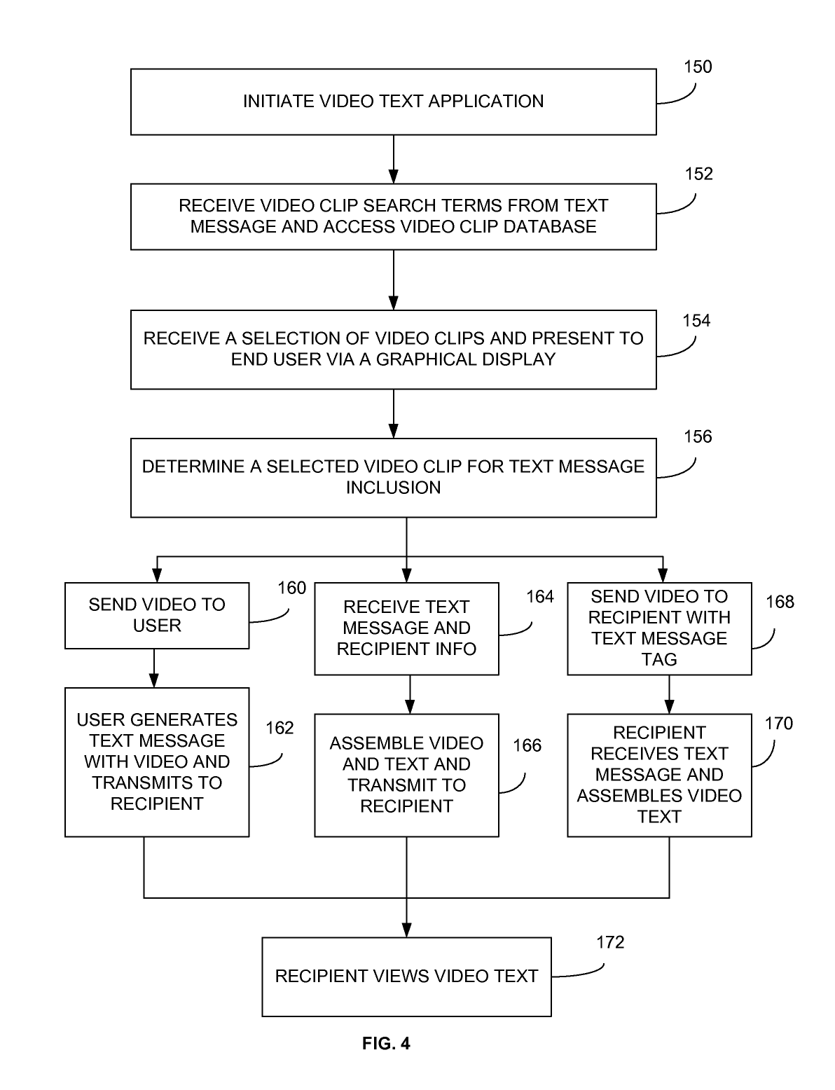

For the sake of brevity, the operations of the various embodiments of FIG. 1 are described in further detail regarding the steps of FIGS. 3 and 4.

While FIG. 1 illustrates an embodiment having the video texting operations operating through the video text server 106, FIG. 2 illustrates an alternative embodiment of a system 120 for video texting. The system 120 includes the sender 102 with mobile device 104, recipient 110 with mobile device 112 and the network 114. The system 120 includes a communication server 122, a video clip access server 124 and a video clip database 126.

In the embodiment of FIG. 2, the alternative system allows the communication server 122 to interface with the user and the mobile device for the generation, transmission and viewing of a video text. As described in further detail below, the system 120, via the communication server 122 facilitates reduced content transmission by sending pointers to video content instead of actual video content, or otherwise using pointers to video content to reduce transmission bandwidth during the video texting process. The communication server 122 may be one or more servers allowing for various functionalities, including searching interface, as well as interfacing with the mobile device for video text generation and video text transmission. The video clip access server 124 allows access to the video database 126, thus based on various embodiments, users can access the video content for either searching and video selection, transmission to the recipient, and/or facilitating recipient viewing of the video clip. Compared with prior art systems, the present technique embeds the searching operation directly with the text messaging operation into a single unitary interface.

For the sake of brevity, the operations of the various embodiments of FIG. 2 are described in further detail regarding the steps of FIGS. 3 and 4.

In the video databases 108 of FIGS. 1 and 126 of FIG. 2, the system, in one embodiment, utilizes suitable public domain films. From these public domain films, the database holds shortened clips for use in video texting. In addition to public domain content, proprietary content can also be used, generated by users, including user generation of content for the video database, including corresponding content meta data usable for searching, as well description data usable for user selection of content.

In addition, the content can be proprietary content used with permission from current owners for a variety of purposes. For example, a movie studio might provide a number of video clips for an upcoming release (new movie, DVD/On-Demand release, sequel, re-mastered or re-released, etc.) to help generate interest or buzz in their content. A television studio or sports content entity may release content for promotions, such as promoting a new upcoming season or a sports channel releasing videos of memorable sporting events. Similarly, business or advertisers may release content having a financial benefit to another party, such as having memorable commercial content made available. Another example may be video game and/or gaming content manufacturers releasing segments from a video game to help promote or otherwise draw attention to their products.

The video text messaging system may also utilize varying levels of user access controls based on subscription or user-priority determinations. While not expressly illustrated in FIGS. 1-2, the video text messaging server 106 and/or the video clip access server 124 may include user account registration and/or login interfacing operations. For example, a registered user may enter login information using a secured network connection using known security operations. The user is registered for a particular level of content or is otherwise granted access to particular content that may be included in the video text message. Therefore, the registered user has a greater selection of available video clips, such as proprietary video clips not generally accessible to the public.

For example, a user may have an account with the video text messaging server or in another embodiment the account may be through an ancillary service or service provider. By way of example, a user may have a subscription to a video on-demand or instant viewing service, and based on that subscription, has the proprietary right to access the corpora of proprietary content.

In another embodiment, the video text messaging system can include a free service with a video text messaging application including the operations described herein, but having restricted access to video content. The free service can include access to publicly available video content. In another embodiment, the free service can include additional visibility for a user to see what content is not available under the free service, including for example providing search results that include both free and paid content, but only allowing the user to access and/or use the free content.

Another embodiment may include using advertising to offset or otherwise subsidize subscription costs. For example, a user may have a free subscription to a video text messaging system that includes access to a larger sample of video content, but that content includes advertising content. The advertising content may be embedded product placement, a banner ad or other passive advertisement, a short commercial before or after the video clip or any other suitable type of advertisement. In this same embodiment, a user may opt out of the advertised content by paying a subscription or otherwise having authorization to the content.

The various embodiments provide for subscription and user access ancillary to the video text messaging interface. The user has an account level or registration, and based on that, has limited or controlled access to various content. Unlike prior techniques for video text messaging, the user does not have to navigate a first interface for purchase or financial information and then a secondary interface for text messaging. The current video text messaging system and method provides multi-level user subscription access in a single seamless interface, thereby improving the usability of the messaging application and reducing user confusion.

Regardless of the specific content described above, it is recognized that any number of sources can be readily used for content. The above examples are not limiting in nature, as it is recognized by many additional content sources can be utilized and hence are within the scope of the present invention.

In another embodiment, users can create their own video segments and upload them for use as video text messages. Content management techniques currently employed may be utilized to facilitate the video segments so they are usable for video texting operations. For example, crowd-sourcing operations may be utilized to provide descriptions and meta-data associated with the content. This meta-data and descriptions are usable for searching operations. Similarly, public feedback or other techniques may be utilized to filter or otherwise percolate relevant content for use in the video texting operations, such as for example attributing the popularity of a video segment to its being pertinent and well-usable. These operations can help streamline the searching operations so the end user can quickly ascertain the best available video content for video texting operations.

As noted above, similar to the content of the video, the descriptions of the video content provide back-end functionality as well as user-interface benefits. Video descriptions can provide the user with descriptive information for quickly selecting a desired video. For example, by having a descriptive caption associated with a video, the user can quickly ascertain and select a video segment instead of having to watch multiple video clips to decide which one is appropriate. This descriptive content can take any number of forms, including descriptions by the content generator, community-generated tags, a filter of most-frequently used text words associated with the video (i.e. tracking the content of the video texts that use the video clip and determine which words appear the most often, discarding stopwords), or any other suitable technique.

In one embodiment, the video content is not expressly restricted just to the video element. One embodiment includes the insertion of an advertisement component in the video content. One technique may be product placement into the existing video. For example, into a black and white video text message, the method and system unobtrusively inserts a colorized photo of a product. For example, a bottle of alcohol beverage manufacturer stands silent sentry on the bar in a video text, “Wanna have a drink?” A coffee chain's recognizable cup with logo lingers on a table in a Video text, “Let's have coffee.” Another technique may include the use of a tag. At the very end of a video text message, show a sponsor's Logo/Trademark and employ a cut line that resonates with the preceding video content. Another advertising technique is a micro-commercials. Existing television commercials may be used to generate the video content. For example, take one of the best Super Bowl commercials, and turn it into a humorous and/or emotional 5-10 second item. Thus, the video of the video text itself can be a segment of a commercial. Other advertising techniques are envisioned herein and the present invention is not expressly limited to the techniques listed.

Another embodiment of the video text messaging system and method allows for further user customizations of the interface. For example, users may apply customizations to the interface itself, such as the application of a particular skin or other personalization.

FIG. 3 illustrates a flowchart of the steps of one embodiment of a method for performing video texting, also known as video texting. The flowchart of FIG. 3 illustrates one embodiment is not a limiting embodiment, as modifications recognizable to those skill in the art are envisioned herein. In this exemplary embodiment, a first step, step 130, is the user initiating a video text application. In one embodiment, this may be an application running on a mobile device, such as running on top of the mobile processing device platform. By way of example, but not limiting in nature, the video texting application may be launched on an Android® operating platform, Microsoft Windows® operating platform or any other suitable platform. This launching can include the user selecting an application icon and the mobile device engaging the video texting interface, wherein in one embodiment the video texting may be a stand alone application for execution on the platform, or in another embodiment, the video texting may be embedded in the platform itself as a function or operational capability of the platform.

A next step, step 132, is to receive video clip search terms and access a video clip database. Relative to FIG. 1, in this embodiment the user 102 enters a text message into the mobile device 104 and the content of the text message itself are the search terms. In the system 100 of FIG. 1, the mobile device 104 communicates across the network 114 such that the video text server 106 processes the search request and accesses the database 108. By contrast, in the embodiment of FIG. 2, the communication server 122 may be the wireless service provider or any other intermediary party facilitating access to the video clip access server 124. Therefore, the searching interface and the text messaging interface all within the same system.

By contrast, prior techniques required separate systems for monetization purposes, such as the first interface to search and purchase a video and a second interface to include a text message with the video. The video text messaging system and method allows for the insertion of a text message as the search terms. One embodiment may include additional language conversion techniques similar to natural language conversion operations. While current searching technology allows for natural language search based on search term manipulation algorithms, those techniques can be applied to conversion of text messaging language. Text messaging has its own vocabulary, therefore processing operations provide for the translation of text messaging language into search terms. By way of example, the letters “LOL” are shorthand indicating something is funny, therefore a language conversion algorithm converts the letters “LOL” into searchable terms usable by the video content search processing devices.

A next step, step 134, is to receive a selection of video clips and present to the end user via a graphical interface. In one embodiment, this may include the transmission of multiple thumbnails with a description of the video content. In one embodiment, the user can then scroll through the list of available clips, seeing the thumbnails, the description of the video and associated message of the video clip. This display is viewable on the mobile device 104 so, in this embodiment, the thumbnail and corresponding data is sent back to the mobile device across the network 114.

The user can select various thumbnails and then view all or a portion of the video clip. After sampling different video clips, the next step of this embodiment, step 136, is determining a selected clip for text message inclusion. One embodiment may include a selection button, which thereupon places the thumbnail of the video clip into a text messaging window. This operation is seamlessly performed by the user in the single user interface. Based on different embodiments of FIGS. 1 and 2, different back-end, server-side, operations can be performed. For example, in FIG. 1, the video text server 106 may send the full video clip to the sender's mobile device 104 for inclusion into the video text message, whereupon subsequent transmission includes not only the text message, but also full video itself. By contrast, FIG. 2 may provide for the inclusion of a pointer or other type of reference in the video text message such that upon subsequent transmission, the video text message includes the thumbnail and instructions for the recipient's mobile device 112 to access the video clip via the network 114.

Referring back to FIG. 3, a next step, step 138, is to receive text message textual input. This step may have already been performed relative to step 132 above, and/or the user may wish to add additional content or change the text message based on the video, e.g. make a reference to the video clip itself. As noted above, the text message itself is enterable through the text message interface and the text message content becomes the search terms for performing the video search operations. It is recognized that the system and method may include additional text message entry techniques, including for example, but not limited to, speech to text conversion techniques.

A next step, step 140, is to combine or associate the textual input with the selected video. This step may be performed on the mobile device 104 by the video texting application thus merging the text message and the thumbnail or the test message and the video clip. In another embodiment, functionality of step 140 may be performed on the server-side, such as the communication server 122 of FIG. 2 intercepting the text message and thus combining the text message with the video to generate the video text message.

In this embodiment, a final step is the delivery of the message, or a pointer to video clip, to the recipient. On the mobile device, this may include selecting the send button. Where the video clip is embedded in the text, the video text message can be a standard MMS message having the added functionality of the video clip insertion. Therefore, from the perspective of the mobile device, the user is able to generate a video text message to provide contextual enhancements to previously static text messages.

Additional embodiments may be utilized to further refine the searching and processing operations. In one embodiment, user-based preferences can be noted and used to improve the relevancy of search results. Moreover, those preferences can be used to improve search results in general. In one embodiment, the method and system includes the tracking of selected video content and the associated text messages sent therewith. These can be tracked on a per-user or a community basis. By way of example, suppose tracking indicates that a particular user prefers video clips from a particular genre, e.g. Dry British Humor. Therefore, when the search operations are performed, the user's search results may be filtered with this genre being given a higher priority. In another example, supposed the video texting community regularly uses a particular text message with a video clip, the meta data associated with the video clip may be adjusted to reflect this common usage. Therefore, the video text messaging system includes feedback techniques for improving search result operations based on user activities.

FIG. 4 illustrates another embodiment of a method for video texting, such as from the server-side, e.g. server 106 of FIG. 1 and/or servers 122 and 124 of FIG. 2. A first step, step 150, is the receipt of a search inquiry. The search query is either the text message itself or one or more portions of the text message, including for example the first several terms of the text message or in another embodiment the filtering or processing of the text message, such as the determination of key terms or the removal of stop words. This step may be via the transmission of a search request from the mobile device 104 across the network. In response thereto, a corresponding search operation may be performed accessing one or more video content libraries. The search request itself may include a library designation or in another embodiment, multiple libraries are searched based on any number of factors, including if the user is given access to various databases. For example, one embodiment may include a user subscribing to one or more databases of video clips, or users granted access to specific databases based on user account specifics, e.g. having a particular wireless carrier or a particular mobile device manufacturer or platform, etc.

A next step, step 152, is accessing the video clip database and performing the searching. This search may be performed using known searching operations, including searching being performed on, but not limited to, the data associated with the video clip. Therefore, step 154, is to assemble the video clip search result and transmit to the searcher. For example, with respect to FIGS. 1 and 2, this may include the transmission of the search results to the user's mobile device 104 across the network 114. The transmission can include thumbnail and additional data for the user to view and scroll the search results.

While not explicitly illustrated in FIG. 4, the method can revert back to step 150 where a user wishes to change the search and seek new results. Moreover, the method may revert to step 154 if the user scrolls through the full list of transmitted video options and wishes to see a secondary list of video clip options. Once the user is happy with a video selection, step 156 is receiving the video selection command. This step may include the receipt of a selection command sent by the user to the server 106 across the network 114. Where the server transmits the full video clip, this step may be omitted because the mobile device already locally possesses the video clip. As described further below, this step 156 may be functionally different based on the corresponding operating embodiment.

In one embodiment of the flowchart, step 160, the video itself is sent to the sender 102 and thus rests locally on the sender's mobile device. Step 162, the user generates the video text message and this message is sent directly to the recipient. In this embodiment, the video text content is locally hosted on the sender's mobile device 104, therefore the video text server 106 of FIG. 1 and servers 122, 124 of FIG. 2 are ancillary to the transmission to the recipient 110.

By contrast in another embodiment, step 164, the server receive the text message and recipient information. The server therein assembles the video and the text message into a video text, and transmits the video text to the recipient, step 166. In this embodiment, the mobile device 104 provides a data conduit for the processing performed on the server-side of the network, thus reducing the amount of transmitted content and operative in a limited bandwidth environment. Moreover, in limited bandwidth, the transmission may be either the video text with the video, or can be an active link or pointer to video content stored on the network.

By contrast, in yet another embodiment, step 168, the server sends the video to the recipient with a text message tag. Around the same time, the sender 102 sends the text message directly to the recipient 110. In step 170, the recipient receives the text message and the recipient device therein assembles the video text message. This embodiment operates in a distributed fashion thus reducing the bandwidth transmission back to the sender upon video selection.

After steps 162, 166 and 168, method includes step 172, wherein the recipient views the video text message. This viewing can be performed using a video text player located on the recipient's mobile device 112. This viewing may include locally playing the video thereon, or in another embodiment, the mobile device 112 accesses, via the network, the video clip from one or more of the video clip data storage locations.

In response thereto, the recipient can reply using a reply video text message, thus simply repeating the process described above.

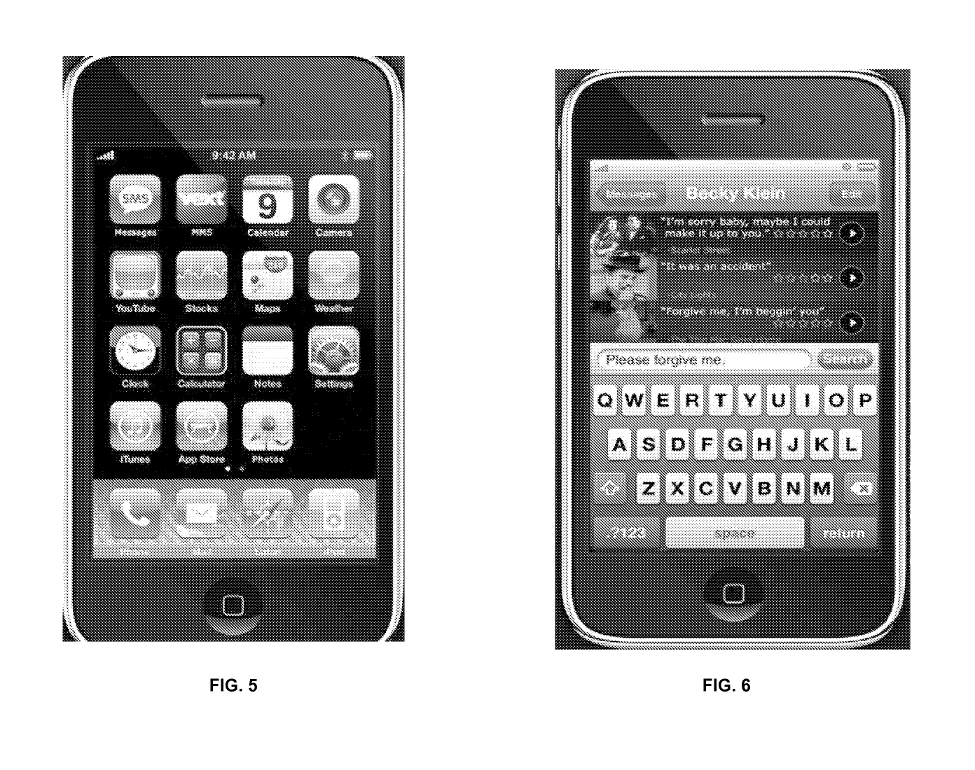

For further illustration of the video texting system and method, FIGS. 5-12 illustrate sample screen shots of the video texting process. FIG. 5 illustrates one embodiment of a mobile device display including the ability to launch a video texting application. FIG. 6 illustrates a screenshot of a user sending a video text requesting the recipient “Becky Klien” to “Please forgive me.” Based on the entrance of these terms via the text message interface, suggested video thumbnails are provided in a display, with corresponding description data and a button to actuate the playing of the video.

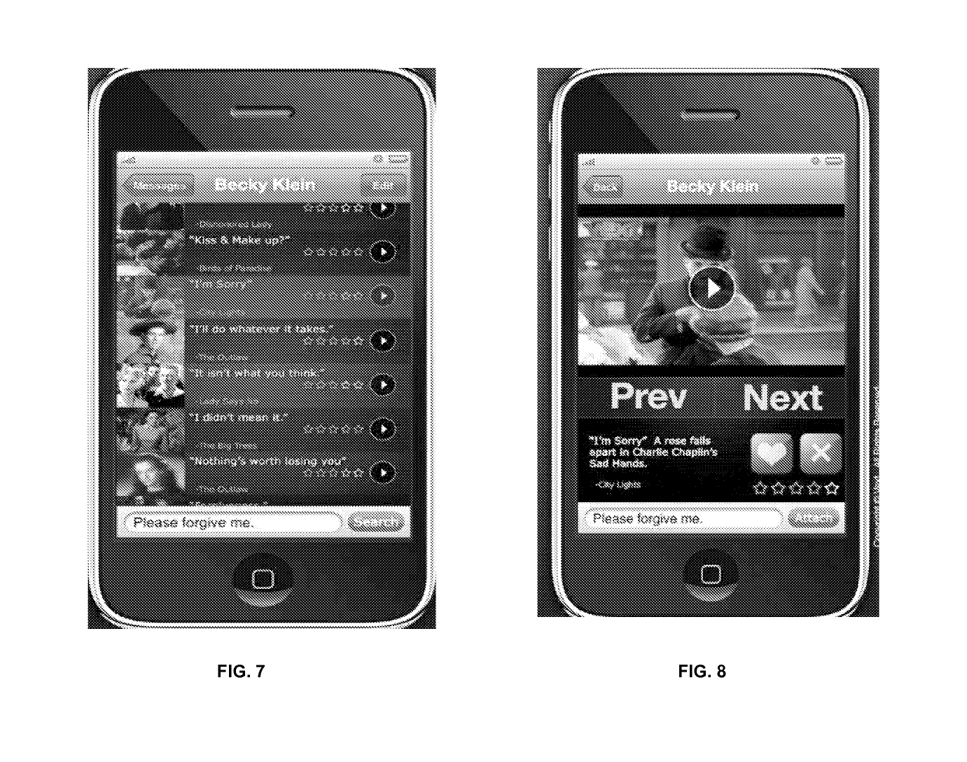

FIG. 7 illustrates another view of a full-screen list of possible videos. This list is scrollable. FIG. 8 illustrates a sample viewer of a video clip, as well as user-interface commands. For example, a user may delete the video from their library, thus in future searches the video is excluded. In another example, the user may indicate a like by pressing the heart icon to indicate this as a favorite video. In another example, the user may select a ranking (shown here as up to 5 stars) so that other users can readily see the star-rankings (which are visible in the screenshots of FIGS. 6-7). Additionally, the user can select a previous video, a next video or select to attach the video to the text message.

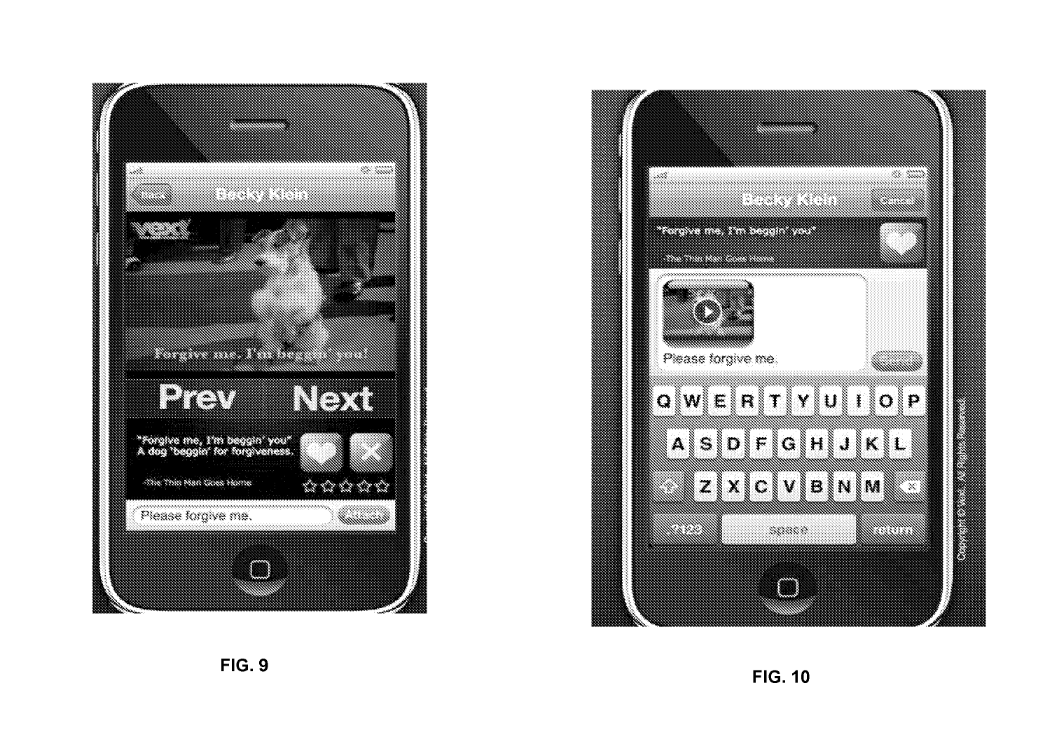

FIG. 9 illustrates the display of an alternative video selection. Presume the user did not desire to use the first video, so this video is then viewed and can be selected for inclusion in the video text message. FIG. 10 illustrates a screenshot of the selected video now encapsulated, via a thumbnail, into the text message interface. Also visible at the top of the video texting interface is the title of the video and corresponding video information. The user can add additional text to the message if desired.

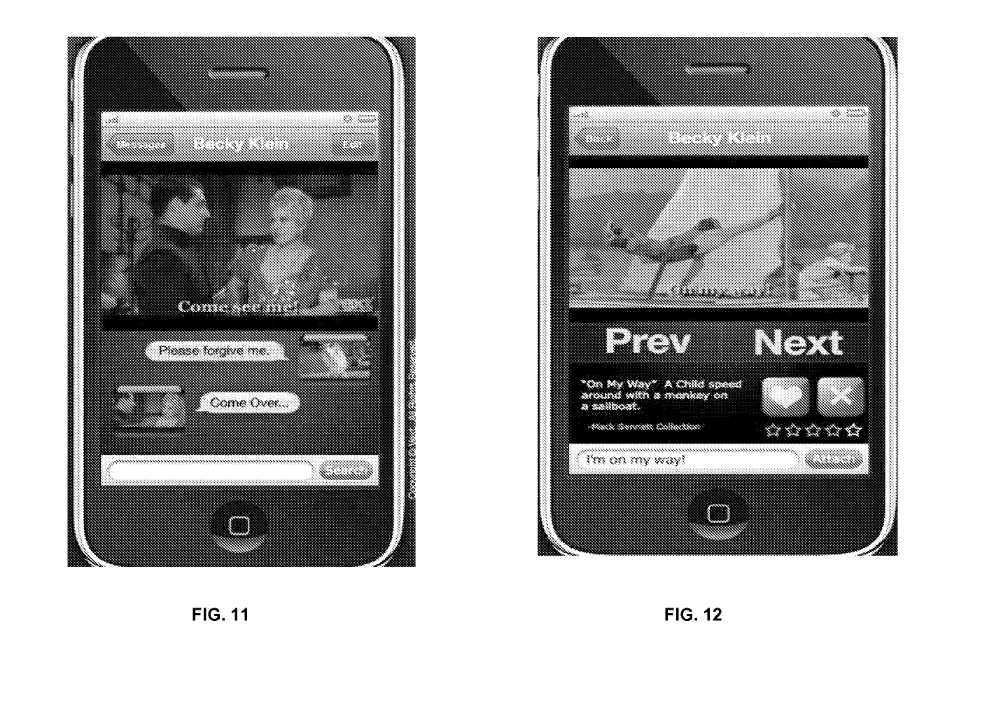

FIG. 11 illustrates a graphical display of the video texting log. The video text has been sent, and a video text has been received, the incoming video text having the text message of “Come Over . . . ” with a corresponding video clip. FIG. 12 illustrate a further follow-up video text message selection for responding indicating that “I'm on my way!”. Thus, the users are able to engage in multiple video text message exchanges through the video texting interface.

Additionally embodiments are envisioned and the invention is not expressly limited to the disclosure herein. For example, a user may maintain a video account either locally or through a server of favorite or preferred videos. The video texting interface provides additional visual benefits to the otherwise static interactions of text messaging in an easy-to-use format.

FIGS. 1 through 12 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

What is claimed is:

1. A method for transmitting a video text message from a first mobile device to a second mobile device, the method comprising:
receiving an input including at least part of a text message from a user via a text messaging application on the first mobile device;
based on the input, determining a search query term for searching one or more libraries of video clips;
accessing the one or more libraries of video clips using the search query term to retrieve a plurality of video clips;
presenting the plurality of video clips to the user in the text message application, including the functionality for viewing each of the video clips within the application;
receiving a user selection of one of the plurality of video clips;
combining the selected video clip with the text message to generate the video message; and
processing the video message for transmission to a text messaging application on the second mobile device such that upon receipt, the video text message is viewable on the second mobile device.

2. The method of claim 1, wherein the combining the selected video clip with the text message further comprises:
transmitting selected video clip to the first mobile device; and
integrating the selected video clip with the text message on the first mobile device.

3. The method of claim 1, wherein the combining the selected video clip with the text message further comprises:
receiving the text message at an intermediate processing device having the video clip thereon; and
integrating the selected video clip with the text message on the intermediate processing device.

4. The method of claim 1, wherein the combining the selected video clip with the text message comprising:
generating an active link to the video clip being hosted on a second processing device;
combining the text message with the active link; and
providing access for the second mobile device to access the video clip upon selection of the active link.

5. The method of claim 1, further comprising:
determining an access account associated with the user;
based on the access account for the user, determining if the user is authorized to use one or more of the plurality of video clips; and
restricting access to one or more of the video clips based on the access account for the user.

6. The method of claim 5, wherein the one or more libraries of video clips include a public library of video clips and a proprietary library, where the user is granted access to the proprietary library if authorized by the user account, else the user is restricted to access to the public library.

7. The method of claim 5, wherein the account access associated with the user includes a subscription to a proprietary library of video clips.

8. The method of claim 1, wherein the video clips includes at least one of: a movie clip, a commercial, a television clip, a music video clip, and user generated content clip.

9. The method of claim 1 further comprising:
accessing a rating information for video clips in the video clip library; and
adjusting a sequence of the video clips in the presenting of the video clips to the user based at least in part on the rating information.

10. An apparatus for transmitting a video text message from a first mobile device to a second mobile device, the apparatus comprising:
a computer readable medium having executable instructions stored therein, and
a processing device, in response to the executable instructions, operate to:
receive an input including at least part of a text message from a user via a text messaging application on the first mobile device;
based on the input, determine a search query term for searching one or more libraries of video clips;
access the one or more libraries of video clips using the search query term to retrieve a plurality of video clips;
present the plurality of video clips to the user in the text message application, including the functionality for viewing each of the video clips within the application;
receive a user selection of one of the plurality of video clips;
combine the selected video clip with the text message to generate the video message; and
process the video message for transmission to a text messaging application on the second mobile device such that upon receipt, the video text message is viewable on the second mobile device.

11. The apparatus of claim 10, wherein the combining the selected video clip with the text message, the processing device, in response to executable instructions, is further operative to:
transmit selected video clip to the first mobile device; and
integrate the selected video clip with the text message on the first mobile device.

12. The apparatus of claim 10, wherein the combining the selected video clip with the text message, the processing device, in response to executable instructions, is further operative to:
receive the text message at an intermediate processing device having the video clip thereon; and
integrate the selected video clip with the text message on the intermediate processing device.

13. The apparatus of claim 10, wherein the combining the selected video clip with the text message, the processing device, in response to executable instructions, is further operative to:
generate an active link to the video clip being hosted on a second processing device;
combine the text message with the active link; and
provide access for the second mobile device to access the video clip upon selection of the active link.

14. The apparatus of claim 10, the processing device, in response to executable instructions, is further operative to:
determine an access account associated with the user;
based on the access account for the user, determine if the user is authorized to use one or more of the plurality of video clips; and
restrict access to one or more of the video clips based on the access account for the user.

15. The apparatus of claim 14, wherein the one or more libraries of video clips include a public library of video clips and a proprietary library, where the user is granted access to the proprietary library if authorized by the user account, else the user is restricted to access to the public library.

16. The apparatus of claim 14, wherein the account access associated with the user includes a subscription to a proprietary library of video clips.

17. The apparatus of claim 10, wherein the video clips includes at least one of: a movie clip, a commercial, a television clip, a music video clip, and user generated content clip.

18. The apparatus of claim 10, the processing device, in response to executable instructions, is further operative to:
access a rating information for video clips in the video clip library; and
adjust a sequence of the video clips in the presenting of the video clips to the user based at least in part on the rating information.
